(19) United States
(12) Patent Application Publication
(10) Pub. No.: US 2004/0154418 A1
(43) Pub. Date: Aug. 12, 2004

(54) Mechanical structure presenting a modifiable vibratory property

(75) Inventor: Michel Pompei, Villiers Sur Orge (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson

(21) Appl. No.: 10/756,992

(22) Filed: Jan. 14, 2004

(30) Foreign Application Priority Data
Jan. 24, 2003 (FR) 0300772

(51) Int. Cl. F16H 37/00

(52) U.S. Cl. 74/11

(57) ABSTRACT

The invention relates to a mechanical structure presenting at least one vibratory property, the structure presenting at least one element for modifying said vibratory property, which element is made of a polymer that is flexible and heavy, e.g. containing massive filler material.

The present invention relates to a mechanical structure presenting an acoustic property of which use is made, for example a critical frequency or a response to vibration transmitted by a carrying structure.

### BACKGROUND OF THE INVENTION

It is often advantageous to be able to vary the impedance of a structure or to modify a useful vibratory property such as its natural vibratory behavior and/or its radiation of sound.

To do this, action is often taken on the stiffness of the structure at suitable points. This action is applied by means of stiffeners which also modify the mass of the structure.

These combined actions do not always have effects that operate in the same direction. It is therefore desirable to have improved means for implementing such impedance modifications.

### OBJECTS AND SUMMARY OF THE INVENTION

The invention is based on the idea of acting solely on the mass term, while modifying the term associated with elasticity very little or not at all, with this being obtained by means of an element made of a material that is both heavy and flexible.

The invention thus provides a mechanical structure presenting at least one vibratory property, the structure presenting at least one element secured to a region of the structure in order to modify said vibratory property, which element is a flexible and heavy polymer containing, for example, filler material that is massive.

Advantageously, the flexible polymer presents a modulus lying in the range 10⁴ Pascals (Pa) to 10⁷ Pa, and preferably lying in the range 10⁵ Pa to 10⁶ Pa.

The flexible polymer filled with said massive filler advantageously presents specific gravity greater than 2 and less than or equal to 10, and preferably lying in the range 3 to 10. The filler advantageously presents specific gravity lying in the range 3 to 18 and a particle size lying in the range 10micrometers (μm) to 2000μm.

In a first variant, the structure is constituted at least in part by a honeycomb type panel comprising two outer plates with an array of cells disposed between them, and at least some of said cells are filled with a said element made of flexible and heavy polymer.

In a second variant, the structure is constituted by a load-carrier frame presenting at least one opening in which a plate is engaged or fixed, and the structure presents at least one strip or at least one plate made of a said flexible and heavy polymer which is fixed to at least a portion of the perimeter of at least one said plate. In particular, at least one plate of flexible and heavy polymer may be fixed to a corner of the plate which is engaged or fixed in the load-carrier frame.

In a third variant, the structure presents at least one fixing hole arranged around a region of the structure, and the structure presents at least one ring made of a said filled flexible polymer secured to the structure and surrounding said fixing hole.

### BRIEF DESCRIPTION OF THE DRAWINGS

Other characteristics and advantages of the invention appear on reading the following detailed description given with reference to the accompanying drawings, in which:

FIGS. 1 to 3 show three variant embodiments of the invention; and

FIGS. 4 and 5 show the sound improvement provided by the FIG. 3 structure under two conditions of excitation.

### MORE DETAILED DESCRIPTION

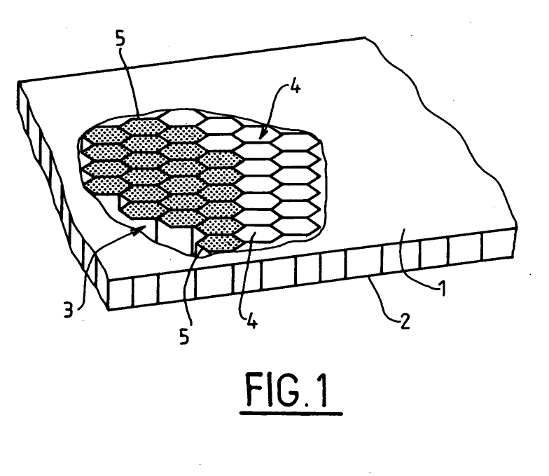

FIG. 1 shows a honeycomb panel presenting two plates 1 and 2 having sandwiched between them an array 3 of hexagonal cells 4. Some of the cells are filled with a polymer having a very low modulus (e.g. lying in the range 10⁴ Pa to 10⁷ Pa, and preferably in the range 10⁵ Pa to 10⁶ Pa) filled with a heavy filler, e.g. metal and/or mineral particles of dimensions lying in the range 0.01 millimeters (mm) to 2 mm. The specific gravity of the filler must be greater than that of the fillers (glass fibers or carbon fibers) normally used as mechanical reinforcing fillers for rubber. This produces a change in the vibratory behavior of the honeycomb panel and a change in the critical frequency of the panel. The number of cells can be selected, and is a parameter that makes adaptation possible. The locations of the cells 4 that are to be filled with material 5 can be selected in order to localize the resulting effect.

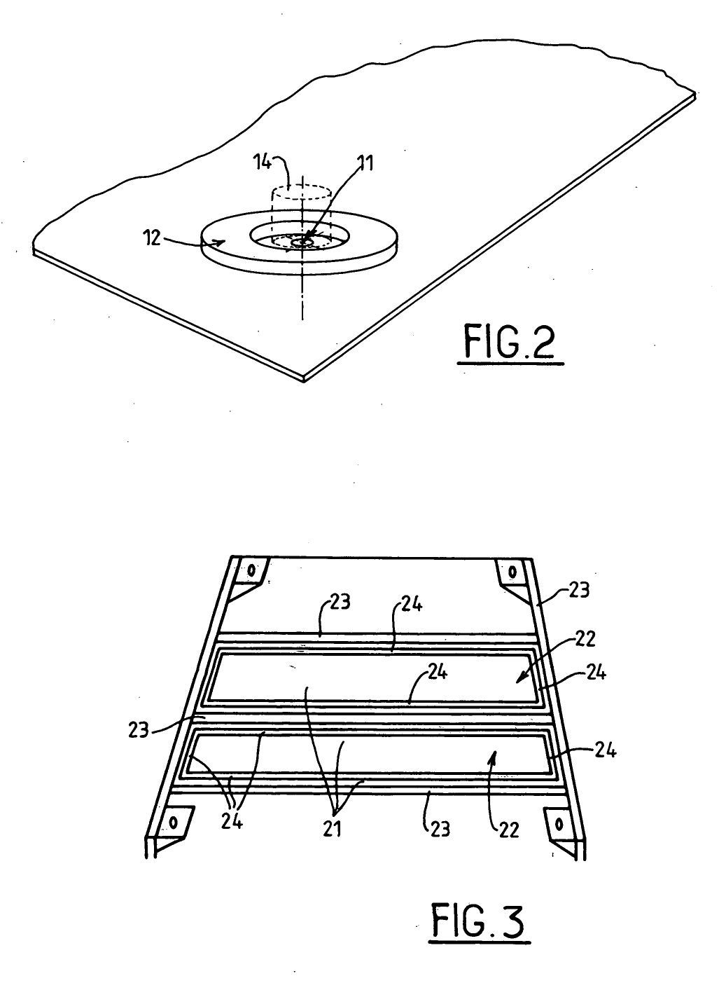

FIG. 2 shows a plate 10 presenting a fixing hole 11. The plate 10 may be a fixing tab for a mechanical structure, or more generally a region of a mechanical structure which can be fixed by means of a fixing hole 11.

In accordance with the invention, a ring 12 of flexible polymer containing heavy filler material is fixed on the plate 10 so as to surround the fixing hole 11. The ring 12 is preferably concentric about the fixing hole 11. The effect obtained is a local modification to mechanical impedance which leads to vibratory waves entering the panel at this point being reflected. Vibration communicated to the plate 10 by a fixing point 14 (shown in dashed lines) is thus attenuated by the ring 12 whose mass makes it possible to adapt the frequency range in which attenuation occurs.

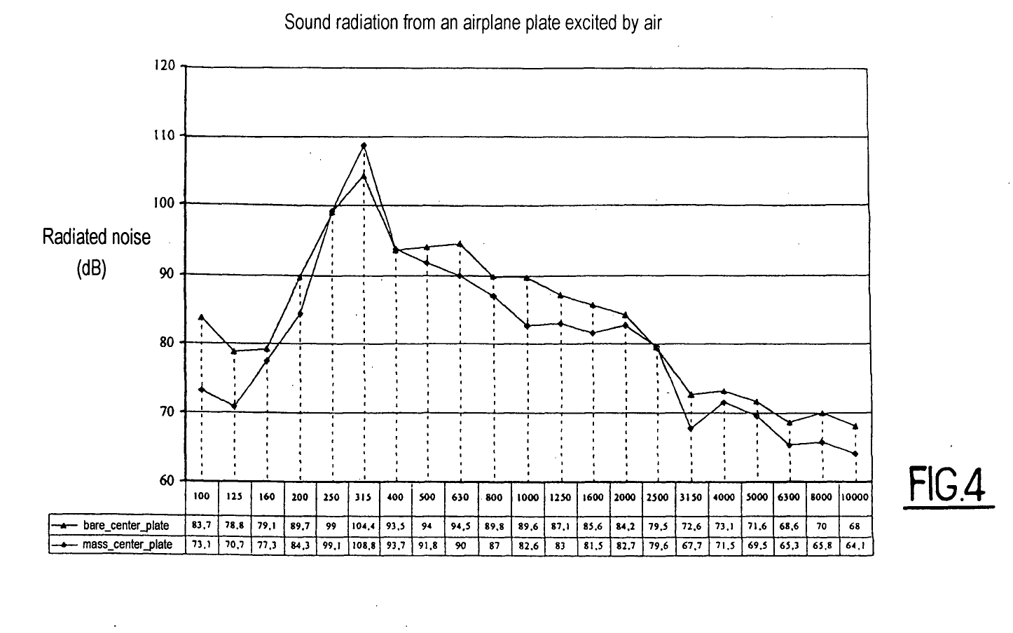

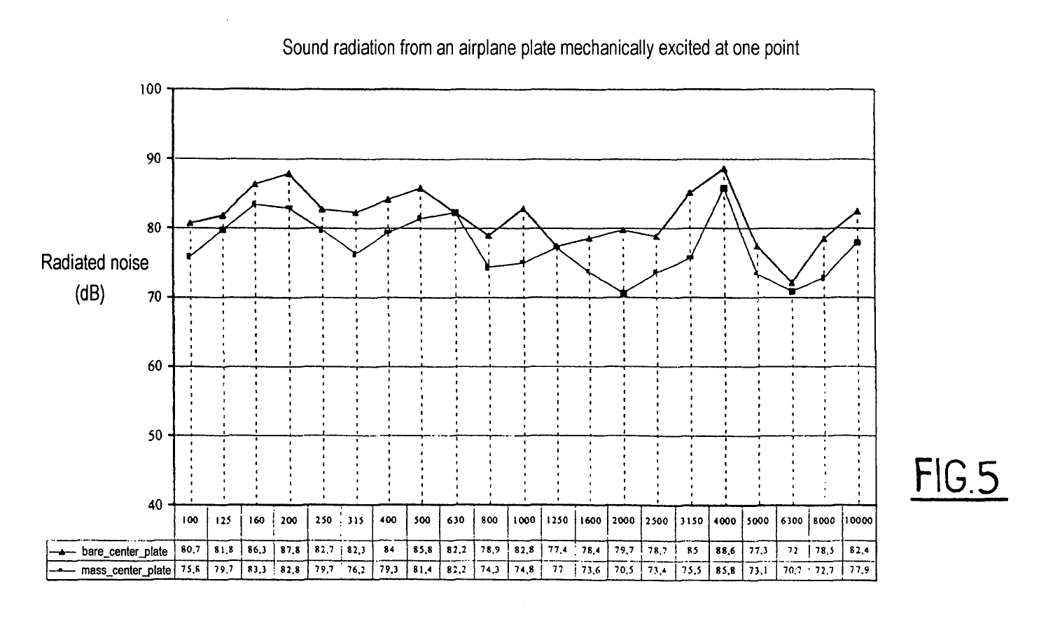

The structure shown in FIG. 3 presents plates 21 which are peripherally engaged in openings 22 of a load-carrier frame 23 constituting a trellis. By way of example, the plates 21 are aircraft fuselage panels engaged between frames and stringers. One or more narrow strips 24 (e.g. 5 mm to 10 mm wide and 2 mm to 4 mm high) of heavy and flexible material as defined above are stuck to the peripheries of these plates, i.e. in the immediate vicinity of the interface between each plate 21 and the load-carrier frame 23 over at least a fraction of their perimeter. The effect obtained is an attenuation of the sound radiation generated by the plate when sound is transmitted by the load-carrier structure (FIG. 4) being excited, e.g. mechanically, at a point (FIG. 5). Depending on frequency, the attenuation obtained lies in the range 0 decibels (dB) to 10 dB (at 100 hertz (Hz)) in the example shown in FIG. 4, and in the range 0 dB to 9 dB (at 2000 Hz) in the case shown in FIG. 5. At least one corner of the plate 21 may receive a plate of heavy and flexible material that is fixed thereon, e.g. by adhesive.

Another example of an application is that of modifying the critical sound frequency of a panel by locally sticking thereon plates of a material that is both heavy and flexible. The critical frequency depends on the mass and the stiffness of the panel. Any action on either one of these factors leads to action on the other one and the effects may oppose each other, depending on frequency range. Adding plates of material that is both heavy and flexible makes it possible to vary mass while having little effect on stiffness.

An element of heavy and flexible material, e.g. constituted by a flexible polymer containing massive filler material, is particularly effective when the elasticity modulus of the polymer is low and the density of the massive filler is high.

What is claimed is:

1. A mechanical structure presenting at least one vibratory property, the structure presenting at least one element for modifying said vibratory property, which element is made of a flexible and heavy polymer, e.g. containing massive filler material, and the flexible and heavy polymer presents specific gravity lying in the range 3 to 10 and said element is secured to a region of the structure.

2. A structure according to claim 1, wherein said polymer presents a modulus lying in the range 10⁴ Pa to 10⁷ Pa.

3. A structure according to claim 1, wherein the polymer is polyurethane, silicone, natural rubber, or synthetic rubber.

4. A structure according to claim 1, presenting massive filler material constituted by metal and/or mineral particles.

5. A structure according to claim 1, the structure being constituted at least in part by a honeycomb type panel comprising two outside plates with an array of cells disposed between them, and at least some of said cells are filled with a said element of flexible and heavy polymer.

6. A structure according to claim 1, the structure being constituted by a load-carrier frame presenting at least one opening in which a plate is engaged or fixed, and the structure presenting at least one strip or plate of a said flexible and heavy polymer which is fixed to at least a portion of the perimeter of at least one said plate which is engaged or fixed to the load-carrier frame.

7. A structure according to claim 6, presenting at least one plate made of a said flexible and heavy polymer and at least one corner of a said plate which is engaged or fixed to the load-carrier frame.

8. A structure according to claim 1, presenting at least one fixing hole arranged around a region of the switches, and further presenting at least one ring of a said filled flexible polymer secured to the structure and surrounding said fixing hole.
